(19) United States
(12) Patent Application Publication
(10) Pub. No.: US 2022/0294096 A1
(43) Pub. Date: Sep. 15, 2022

(54) POWER COMBINER

(71) Applicant: FUJITSU LIMITED, Kawasaki-shi (JP)

(72) Inventor: Yoshitaka Niida, Atsugi (JP)

(73) Assignee: FUJITSU LIMITED, Kawasaki-shi (JP)

(21) Appl. No.: 17/521,408

(22) Filed: Nov. 8, 2021

(30) Foreign Application Priority Data
Mar. 15, 2021 (JP) 2021-041215

(51) Int. Cl. H01P 5/16; H01P 3/08; H01P 3/12; H01P 5/107

(52) U.S. Cl. CPC H01P 5/16; H01P 3/081; H01P 3/12; H01P 5/107

(57) ABSTRACT

A power combiner includes a first substrate provided with a first microstrip line, a second substrate provided with a second microstrip line, and a hollow waveguide having a metal film on an inner wall of a hollow and coupled to the first microstrip line and the second microstrip line, the hollow waveguide combining a first electric power transmitted through the first microstrip line and a second electric power transmitted through the second microstrip line and transmitting a combined electric power.

### CROSS-REFERENCE TO RELATED APPLICATION

This application is based upon and claims the benefit of priority of the prior Japanese Patent Application No. 2021-041215, filed on Mar. 15, 2021, the entire contents of which are incorporated herein by reference.

### FIELD

A certain aspect of embodiments described herein relates to a power combiner.

### BACKGROUND

There has been known a structure in which microstrip lines are provided on both faces of a substrate having dielectric layers formed on both faces of a grounding conductor substrate in order to mount microstrip lines densely. In this case, to guide the electromagnetic wave transmitted through one of the microstrip lines to the other of the microstrip lines, it is known to provide a connecting hole to the grounding conductor substrate and provide a chassis that shields the electromagnetic wave emitted from the connecting hole as disclosed in, for example, Japanese Patent Application Publication No. 2006-101286.

### SUMMARY

In radar systems and communication systems for mobile phones or the like, to achieve high output power, a plurality of transistors is arranged in parallel and the output powers of these transistors are combined by a power combiner. As such power combiners, tournament-shaped power combiners are known. However, in the tournament-shaped power combiner, the power combiner itself becomes large.

According to an aspect of the embodiments, there is provided a power combiner including: a first substrate provided with a first microstrip line; a second substrate provided with a second microstrip line; and a hollow waveguide having a metal film on an inner wall of a hollow and coupled to the first microstrip line and the second microstrip line, the hollow waveguide combining a first electric power transmitted through the first microstrip line and a second electric power transmitted through the second microstrip line and transmitting a combined electric power.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a perspective view of a power combiner in accordance with a first embodiment.

FIG. 2 is a cross-sectional view taken along line A-A in FIG. 1.

FIG. 3 is an exploded perspective view of the power combiner in FIG. 1.

FIG. 4A and FIG. 4B are perspective views of a line substrate.

FIG. 5A and FIG. 5B are perspective views of another line substrate.

FIG. 6A and FIG. 6B are perspective views of an intermediate substrate.

FIG. 7 is a cross-sectional view illustrating the operation of the power combiner in accordance with the first embodiment.

FIG. 8A and FIG. 8B are plan views of a power combiner in accordance with a comparative example.

FIG. 9 is a cross-sectional view of a hollow waveguide in FIG. 8A and FIG. 8B.

FIG. 10 is a perspective view of a power combiner in accordance with a second embodiment.

FIG. 11 is a cross-sectional view taken along line A-A in FIG. 10.

FIG. 12 is an exploded perspective view of the power combiner in FIG. 10.

FIG. 13A and FIG. 13B are perspective views of the intermediate substrate.

FIG. 14 is a cross-sectional view illustrating the operation of the power combiner in accordance with the second embodiment.

FIG. 15 illustrates dimensions used in a simulation.

FIG. 16 presents simulation results of the electric field vectors of the power combiner in accordance with the second embodiment.

FIG. 17 presents simulation results of the loss characteristic of the power combiner in accordance with the second embodiment.

FIG. 18A is a cross-sectional view of a power combiner in accordance with a third embodiment, and FIG. 18B is a cross-sectional view illustrating the operation of the power combiner in accordance with the third embodiment.

FIG. 19 is a cross-sectional view of a power combiner in accordance with a fourth embodiment.

FIG. 20 is a cross-sectional view of a power combiner in accordance with a fifth embodiment.

### DESCRIPTION OF EMBODIMENTS

Hereinafter, with reference to the accompanying drawings, embodiments of the present disclosure will be described.

### First Embodiment

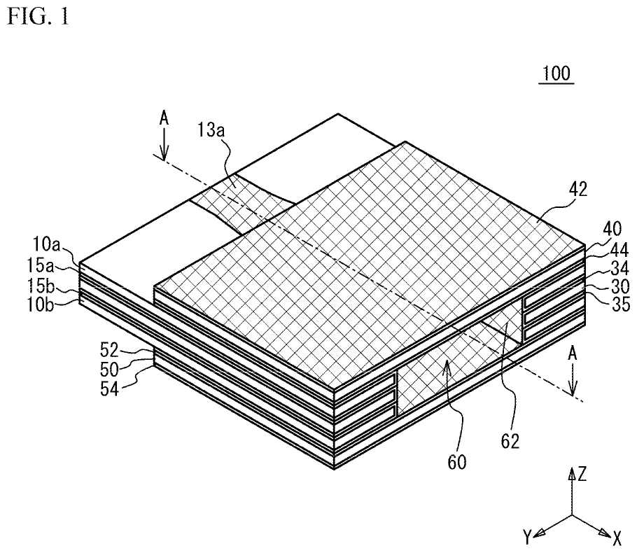

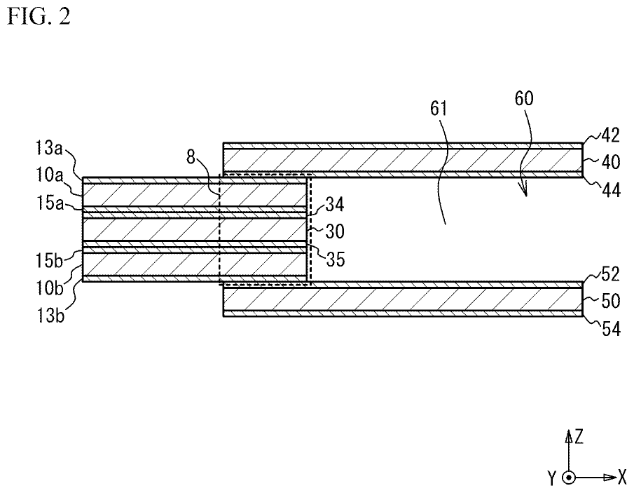

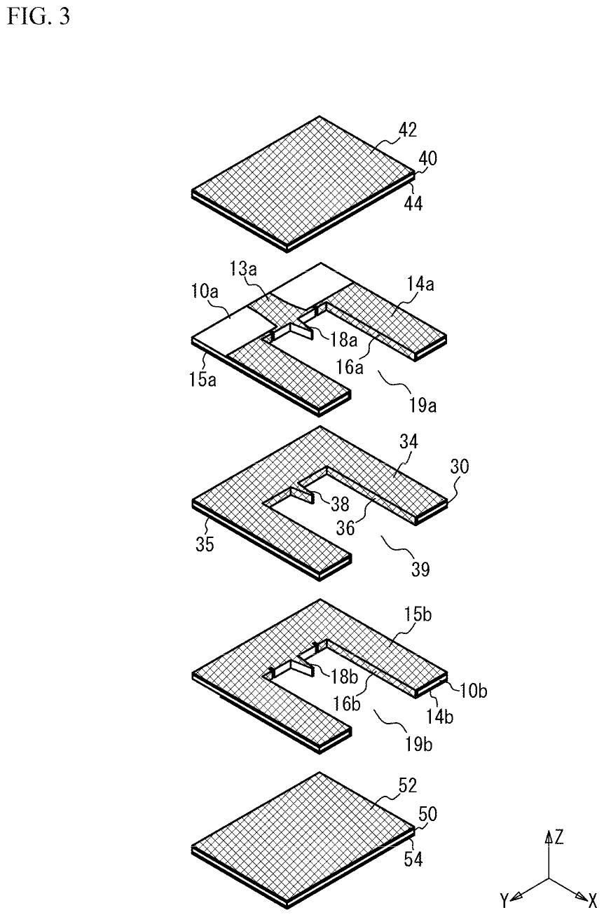

FIG. 1 is a perspective view of a power combiner 100 in accordance with a first embodiment. FIG. 2 is a cross-sectional view taken along line A-A in FIG. 1. FIG. 3 is an exploded perspective view of the power combiner 100 in FIG. 1. The power combiner 100 combines the output powers of, for example, transistors connected in parallel to transmit combined power, and is used in various systems such as, but not limited to, radar systems or communication systems for mobile phones. As illustrated in FIG. 1 to FIG. 3, the power combiner 100 includes a line substrate 10a provided with a microstrip line 13a, a line substrate 10b provided with a microstrip line 13b, and a hollow waveguide 60. The direction in which the microstrip lines 13a and 13b extend (an extension direction) is defined as an X-axis direction, the width direction is defined as a Y-axis direction, and the direction in which the line substrates 10a and 10b are stacked (a stack direction) is defined as a Z-axis direction. In the following description, when referring to the vertical direction of the power combiner, the positive direction in the Z-axis direction is the upward direction, and the negative direction in the Z-axis direction is the downward direction.

The microstrip line 13a is provided on the upper face of the line substrate 10a, and the lower face of the line substrate 10a is covered with a metal film 15a. The microstrip line 13b is provided on the lower face of the line substrate 10b, and the upper face of the line substrate 10b is covered with a metal film 15b. The metal films 15a and 15b are grounding conductor films provided on the opposite faces of the line substrates 10a and 10b from the microstrip lines 13a and 13b, respectively.

An intermediate substrate 30 is interposed between the line substrate 10a and the line substrate 10b. The upper face of the intermediate substrate 30 is covered with a metal film 34, and the lower face of the intermediate substrate 30 is covered with a metal film 35. The metal film 34 is in contact with the metal film 15a provided on the lower face of the line substrate 10a, while the metal film 35 is in contact with the metal film 15b provided on the upper face of the line substrate 10b.

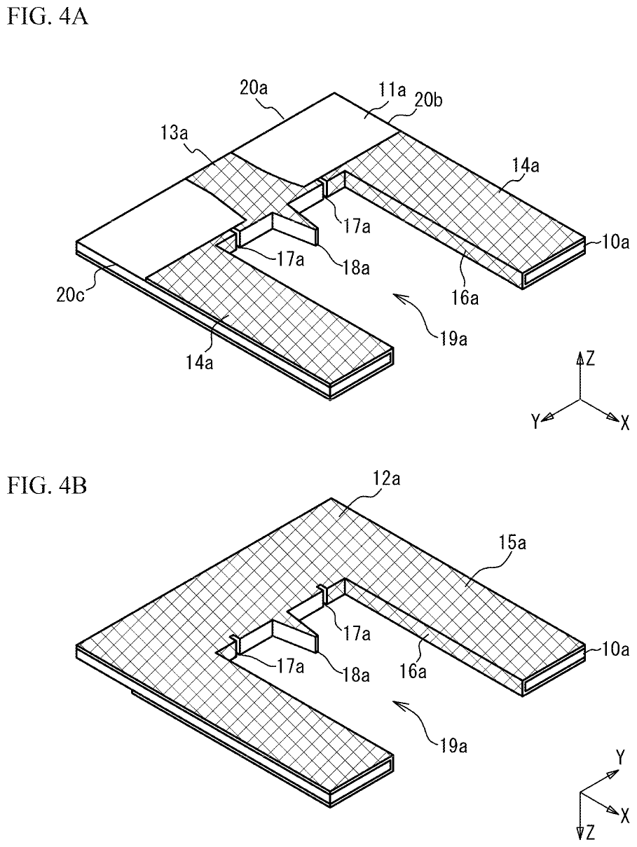

Here, the line substrates 10a and 10b and the intermediate substrate 30 will be described in detail. FIG. 4A and FIG. 4B are perspective views of the line substrate 10a. FIG. 4A is a perspective view of the line substrate 10a viewed from the +Z side, and FIG. 4B is a perspective view of the line substrate 10a viewed from the −Z side. As illustrated in FIG. 4A and FIG. 4B, the center part of the line substrate 10a is cut out to form an opening 19a. Additionally, the line substrate 10a includes a protrusion portion 18a that protrudes to the opening 19a from the side face at the side where the microstrip line 13a is provided among the side faces in the opening 19a.

As illustrated in FIG. 4A, the microstrip line 13a provided on the upper face 11a of the line substrate 10a extends from a side 20a of the upper face 11a to the opening 19a. The microstrip line 13a is also provided on the protrusion portion 18a. The width of the microstrip line 13a is constant (the length in the Y-axis direction is constant) to a certain distance from the side 20a, from there, becomes larger in a tapered shape toward the opening 19a, and is further larger near the opening 19a. Metal films 14a are provided between a side 20b intersecting with the side 20a and the opening 19a and between a side 20c intersecting with the side 20a and the opening 19a. The line substrate 10a has two notches 17a on the side face at the side where the microstrip line 13a is provided among the side faces of the opening 19a. The two notches 17a sandwich the protrusion portion 18a therebetween. The notches 17a separate the microstrip line 13a and the metal film 14a from each other.

As illustrated in FIG. 4B, the lower face 12a of the line substrate 10a is covered with the metal film 15a. The metal film 15a is also provided on the protrusion portion 18a.

As illustrated in FIG. 4A and FIG. 4B, a metal film 16a, which is in contact with the metal film 14a and the metal film 15a, is provided on the side faces in the opening 19a of the line substrate 10a. Among the side faces in the opening 19a of the line substrate 10a, no metal film is provided on the side face between the two notches 17a. Thus, no metal film is provided on the side faces of the protrusion portion 18a.

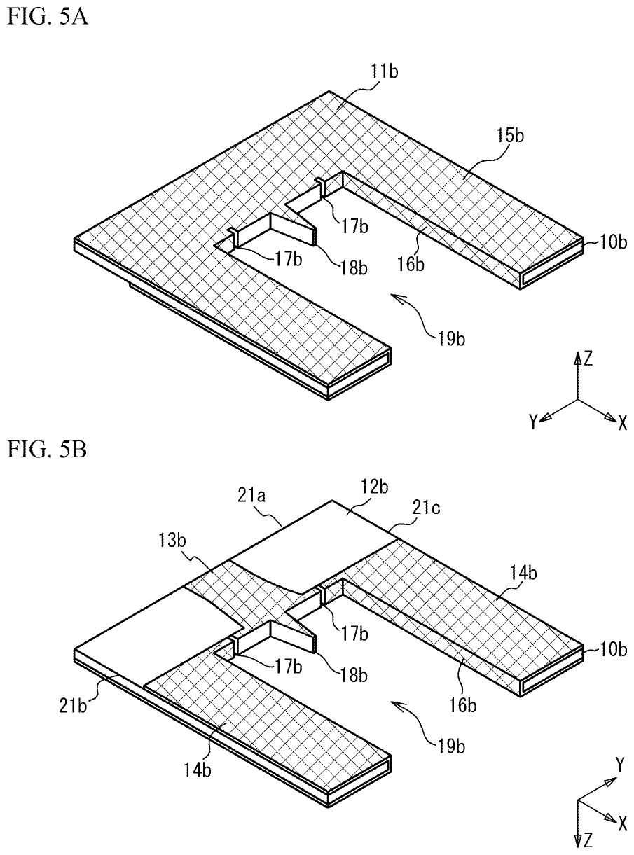

FIG. 5A and FIG. 5B are perspective views of the line substrate 10b. FIG. 5A is a perspective view of the line substrate 10b viewed from the +Z side, and FIG. 5B is a perspective view of the line substrate 10b viewed from the −Z side. The line substrate 10b is a reversed version of the line substrate 10a. As illustrated in FIG. 5A and FIG. 5B, the center part of the line substrate 10b is cut out to form an opening 19b. The line substrate 10b includes a protrusion portion 18b that protrudes to the opening 19b from the side face at the side where the microstrip line 13b is provided among the side faces in the opening 19b.

As illustrated in FIG. 5A, the upper face 11b of the line substrate 10b is covered with the metal film 15b. The metal film 15b is also provided on the protrusion portion 18b.

As illustrated in FIG. 5B, the microstrip line 13b provided on the lower face 12b of the line substrate 10b extends from a side 21a of the lower face 12b to the opening 19b. The microstrip line 13b is also provided on the protrusion portion 18b. The width of the microstrip line 13b is constant (the length in the Y-axis direction is constant) to a certain distance from the side 21a, from there, becomes larger in a tapered shape toward the opening 19b, and is further larger near the opening 19b. Metal films 14b are provided between a side 21b intersecting with the side 21a and the opening 19b and between a side 21c intersecting with the side 21a and the opening 19b. The line substrate 10b has two notches 17b on the side face at the side where the microstrip line 13b is provided among the side faces in the opening 19b. The two notches 17b sandwich the protrusion portion 18b therebetween. The notches 17b separate the microstrip line 13b and the metal films 14b from each other.

As illustrated in FIG. 5A and FIG. 5B, a metal film 16b, which is in contact with the metal film 14b and the metal film 15b, is provided on the side faces in the opening 19b of the line substrate 10b. No metal film is provided on the side face between the two notches 17b among the side faces in the opening 19b of the line substrate 10b. Therefore, no metal film is provided on the side faces of the protrusion portion 18b.

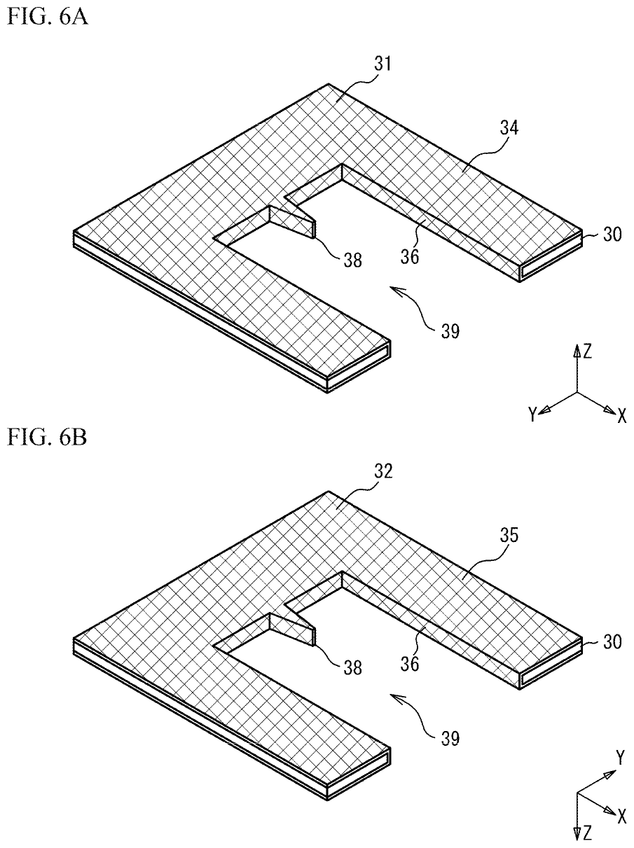

FIG. 6A and FIG. 6B are perspective views of the intermediate substrate 30. FIG. 6A is a perspective view of the intermediate substrate 30 viewed from the +Z side, and FIG. 6B is a perspective view of the intermediate substrate 30 viewed from the −Z side. As illustrated in FIG. 6A and FIG. 6B, the center part of the intermediate substrate 30 is cut out to form an opening 39. The intermediate substrate 30 includes a protrusion portion 38 that protrudes to the opening 39, on the side face in the opening 39. The protrusion portion 38 is provided in a location corresponding to those of the protrusion portion 18a of the line substrate 10a and the protrusion portion 18b of the line substrate 10b.

As illustrated in FIG. 6A, the upper face 31 of the intermediate substrate 30 is covered with the metal film 34. The metal film 34 is also provided on the protrusion portion 38. As illustrated in FIG. 6B, the lower face 32 of the intermediate substrate 30 is covered with the metal film 35. The metal film 35 is also provided on the protrusion portion 38.

As illustrated in FIG. 6A and FIG. 6B, a metal film 36, which is in contact with the metal film 34 and the metal film 35, is provided on the side faces in the opening 39 of the intermediate substrate 30. The metal film 36 is also provided on the side face provided with the protrusion portion 38 of the intermediate substrate 30. Thus, the metal film 36 is also provided on the side faces of the protrusion portion 38.

As illustrated in FIG. 1 to FIG. 3, the line substrate 10b, the intermediate substrate 30, and the line substrate 10a are stacked in this order in the +Z direction. An upper substrate 40 is provided on the upper face of the line substrate 10a and a lower substrate 50 is provided on the lower face of the line substrate 10b so that the respective openings 19a, 39, and 19b of the line substrate 10a, the intermediate substrate 30, and the line substrate 10b are sandwiched between the upper substrate 40 and the lower substrate 50. This forms a hollow 61 formed of the openings 19a, 39, and 19b.

The line substrate 10a and the line substrate 10b are stacked so that the microstrip line 13a and the microstrip line 13b overlap in the Z-axis direction. When the microstrip line 13a and the microstrip line 13b overlap, this means half or greater of the respective areas of the microstrip line 13a and the microstrip line 13b overlap, preferably 80% or greater of the respective areas overlap, more preferably 90% or greater of the respective areas overlap, further preferably 95% or greater of the respective areas overlap.

A metal film 42 is provided on the upper face of the upper substrate 40, and a metal film 44 is provided on the lower face of the upper substrate 40. The metal film 44 is in contact with the microstrip line 13a and the metal film 14a provided on the upper face of the line substrate 10a. The metal film 42 may be omitted.

A metal film 52 is provided on the upper face of the lower substrate 50, and a metal film 54 is provided on the lower face of the lower substrate 50. The metal film 52 is in contact with the microstrip line 13b and the metal film 14b that are provided on the lower face of the line substrate 10b. The metal film 54 may be omitted.

The upper inner wall of the hollow 61 is the lower face of the upper substrate 40, and is covered with the metal film 44. The lower inner wall of the hollow 61 is the upper face of the lower substrate 50, and is covered with the metal film 52. The inner side walls of the hollow 61 are formed of the side faces in the opening 19a of the line substrate 10a, the side faces in the opening 39 of the intermediate substrate 30, and the side faces in the opening 19b of the line substrate 10b. Since the metal films 16a, 36, and 16b are provided on the respective side faces, the inner side walls of the hollow 61 are covered with a metal film 62 formed of the metal films 16a, 36, and 16b. Therefore, the hollow 61 serves as the hollow waveguide 60 through which the electromagnetic wave propagates. The electromagnetic wave propagates through the hollow 61.

The structure of the hollow waveguide 60 is not limited to the structure where the inner side walls are covered with the metal film 62, and may be other structures such as a structure where a through-hole is provided to the line substrates 10a and 10b and the intermediate substrate 30 instead of the metal film 62.

The protrusion portions 18a, 18b, and 38, which are respectively provided to the line substrates 10a and 10b and the intermediate substrate 30, overlap in the Z-axis direction. Here, when the protrusion portions 18a, 18b, and 38 overlap, this means half or greater of the respective areas of the protrusion portions 18a, 18b, and 38 overlap, preferably 80% or greater of the respective areas overlap, more preferably 90% or greater of the respective areas overlap, further preferably 95% or greater of the respective areas overlap. The overlapping protrusion portions 18a, 18b, and 38 are referred to collectively as a protrusion portion 8. The protrusion portion 8 has a function that smoothly converts the propagation modes of the electromagnetic waves between the microstrip line 13a and the hollow waveguide 60 and between the microstrip line 13b and the hollow waveguide 60. Additionally, the wider widths of the microstrip lines 13a and 13b near the openings 19a and 19b allow for low-loss conversion of the electromagnetic waves between the microstrip line 13a and the hollow waveguide 60 and between the microstrip line 13b and the hollow waveguide 60. Even when the protrusion portion 38 is not provided to the intermediate substrate 30, the low-loss conversion of the electromagnetic waves between the microstrip lines 13a and 13b and the hollow waveguide 60 is possible. However, to further reduce the loss, it is preferable to provide the protrusion portion 38 also to the intermediate substrate 30.

The line substrates 10a and 10b, the intermediate substrate 30, the upper substrate 40, and the lower substrate 50 are dielectric substrates, and are formed of, for example, a resin material (a fluorine-based resin material or the like). The microstrip lines 13a and 13b, the metal films 14a and 14b, the metal films 15a and 15b, the metal films 16a and 16b, the metal films 34 to 36, the metal films 42 and 44, and the metal films 52 and 54 are formed of, for example, a conductive metal such as copper.

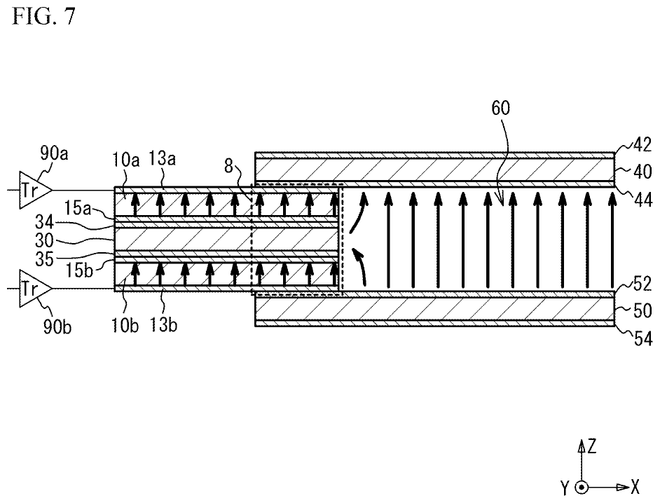

Next, a description will be given of the operation of the power combiner 100 of the first embodiment with reference to FIG. 7. In FIG. 7, arrows express the electric fields generated when the electromagnetic waves propagate through the microstrip lines 13a and 13b. For example, high-frequency signals having reverse phases are input to the microstrip lines 13a and 13b from two transistors 90a and 90b connected in parallel, respectively. For example, a high-frequency signal having an initial phase of 0° is input to the microstrip line 13a, and a high-frequency signal having an initial phase of 180° is input to the microstrip line 13b.

When the electromagnetic waves propagate through the microstrip lines 13a and 13b, the electric fields are generated. The microstrip line 13a is provided on the upper face of the line substrate 10a, while the microstrip line 13b is provided on the lower face of the line substrate 10b. In this case, since high-frequency signals having reverse phases are input to the microstrip lines 13a and 13b, the electromagnetic waves propagating through the microstrip lines 13a and 13b propagate while the directions of the electric fields are substantially the same.

After the propagation modes of the electromagnetic waves propagating through the microstrip lines 13a and 13b are converted by the protrusion portion 8, the electric powers of the electromagnetic waves are combined in the hollow waveguide 60 while the directions of the electric fields are substantially the same. This allows the electric powers to be combined while loss is reduced.

### Comparative Examples

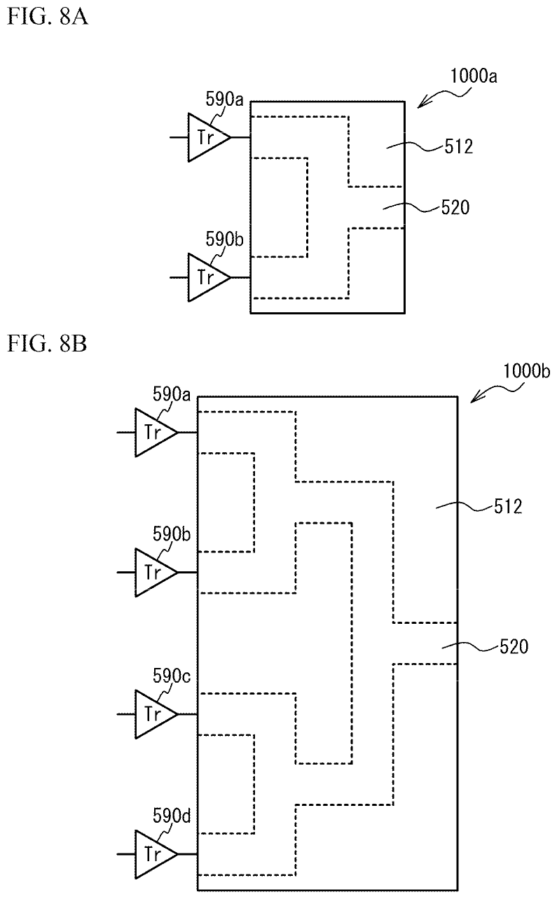

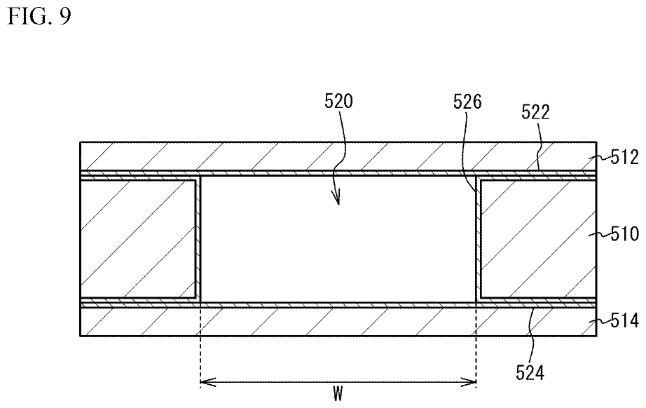

FIG. 8A and FIG. 8B are plan views of power combiners in accordance with comparative examples. FIG. 9 is a cross-sectional view of a hollow waveguide 520 in FIG. 8A and FIG. 8B. A power combiner 1000a of a first comparative example illustrated in FIG. 8A is a single-stage tournament-shaped power combiner, while a power combiner 1000b of a second comparative example illustrated in FIG. 8B is a two-stage tournament-shaped power combiner. In the power combiners 1000a and 1000b, a tournament-shaped circuit is formed by the hollow waveguide 520. The hollow waveguide 520 is formed by interposing a substrate 510 provided with a metal film 526 between a substrate 512 provided with a metal film 522 and a substrate 514 provided with a metal film 524 as illustrated in FIG. 9. An opening is formed in the substrate 510, and the metal film 526 is provided on the side faces of the opening. The hollow surrounded by the metal film 522, the metal film 524, and the metal film 526 serves as the hollow waveguide 520.

The power combiner 1000a of the first comparative example combines the electric powers of high-frequency signals output from two transistors 590a and 590b connected in parallel, using the tournament-shaped circuit, and outputs the combined power. The power combiner 1000b of the second comparative example combines electric powers of high-frequency signals output from four transistors 590a to 590d connected in parallel, using the tournament-shaped circuit, and outputs the combined power.

The width W of the hollow waveguide 520 is approximately ½ of the wavelength of the propagating electromagnetic wave. In the power combiners 1000a and 1000b where such a hollow waveguide 520 is provided in a tournament shape, the power combiner itself becomes larger. Thus, the length of the hollow waveguide 520 increases, resulting in increase in loss.

On the other hand, in the power combiner 100 of the first embodiment, the hollow waveguide 60 is coupled to the microstrip line 13a and the microstrip line 13b as illustrated in FIG. 1 to FIG. 3. The electric power transmitted through the microstrip line 13a and the electric power transmitted through the microstrip line 13b are combined by the hollow waveguide 60 to be transmitted. This structure can make the size in the width direction (the Y-axis direction) of the power combiner 100 approximately equal to the width of one hollow waveguide 60, reducing the size of the power combiner 100. Since the size of the power combiner 100 is reduced, the length of the hollow waveguide 60 decreases, reducing the loss.

Additionally, in the first embodiment, as illustrated in FIG. 1 to FIG. 3, the hollow waveguide 60 is formed of the openings 19a, 39, and 19b of the line substrate 10a, the intermediate substrate 30, and the line substrate 10b that are stacked. This structure makes the size of the power combiner 100 in the width direction (the Y-axis direction) approximately equal to the width of the hollow waveguide 60, and in addition, the size in the height direction (the Z-axis direction) is made to be approximately equal to the total thickness of the substrates. Therefore, the size of the power combiner 100 can be reduced.

In addition, in the first embodiment, as illustrated in FIG. 2 and FIG. 3, the line substrate 10a and the line substrate 10b are stacked so that the microstrip line 13a and the microstrip line 13b overlap in the Z-axis direction (the stack direction). In this structure, the electric power transmitted through the microstrip line 13a and the electric power transmitted through the microstrip line 13b are combined in the hollow waveguide 60 at substantially the same position in the Z-axis direction. Thus, the electric powers can be combined while loss is reduced.

In addition, in the first embodiment, the microstrip line 13a is provided on the upper face 11a, which is the opposite face of the line substrate 10a from the line substrate 10b, while the microstrip line 13b is provided on the lower face 12b, which is the opposite face of the line substrate 10b from the line substrate 10a. In this structure, when high-frequency signals having reverse phases are input to the microstrip line 13a and the microstrip line 13b, the electric powers of the electromagnetic waves are combined in the hollow waveguide 60 while the directions of the electric fields are substantially the same. Therefore, the power combiner 100 supporting a case where high-frequency signals having reverse phases are input is achieved.

In addition, in the first embodiment, the electric power transmitted through the microstrip line 13a is transmitted to the hollow waveguide 60 through the protrusion portion 18a provided to the line substrate 10a. The electric power transmitted through the microstrip line 13b is transmitted to the hollow waveguide 60 through the protrusion portion 18b provided to the line substrate 10b. The protrusion portions 18a and 18b have a function that smoothly converts the propagation modes of the electromagnetic waves between the microstrip line 13a and the hollow waveguide 60 and between the microstrip line 13b and the hollow waveguide 60. Thus, the electric powers can be combined while loss is reduced. In addition, the line substrate 10a and the line substrate 10b are stacked so that the protrusion portion 18a and the protrusion portion 18b overlap in the Z-axis direction (the stack direction). This structure causes the electric power transmitted through the microstrip line 13a and the electric power transmitted through the microstrip line 13b to be combined in the hollow waveguide 60 at substantially the same position in the Z-axis direction. Thus, loss is further reduced, and the electric powers can be combined.

### Second Embodiment

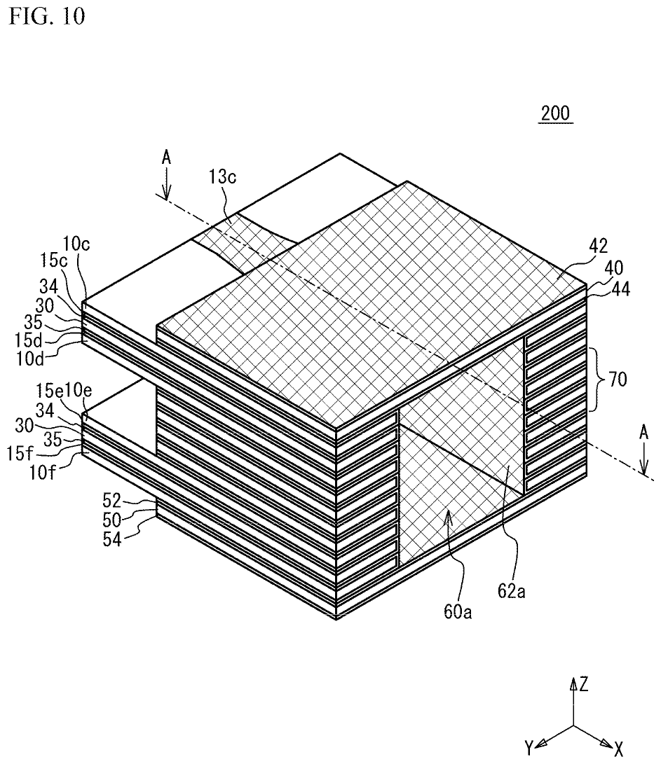

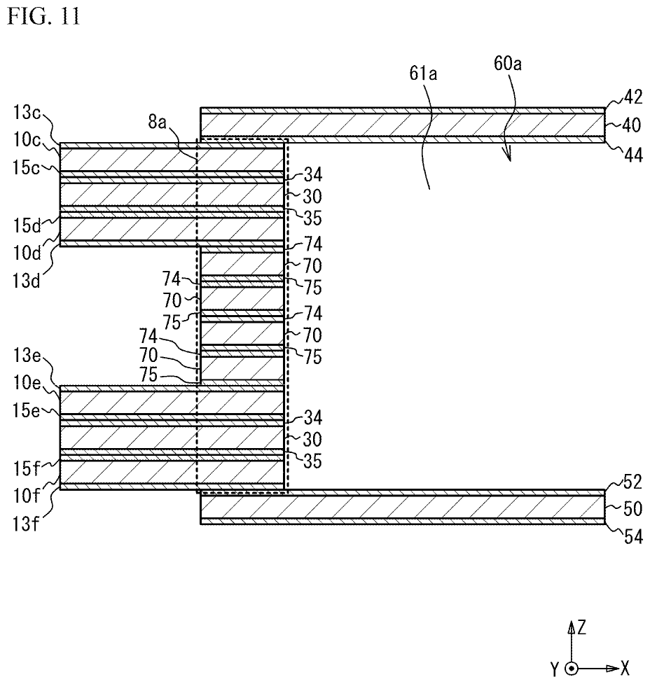

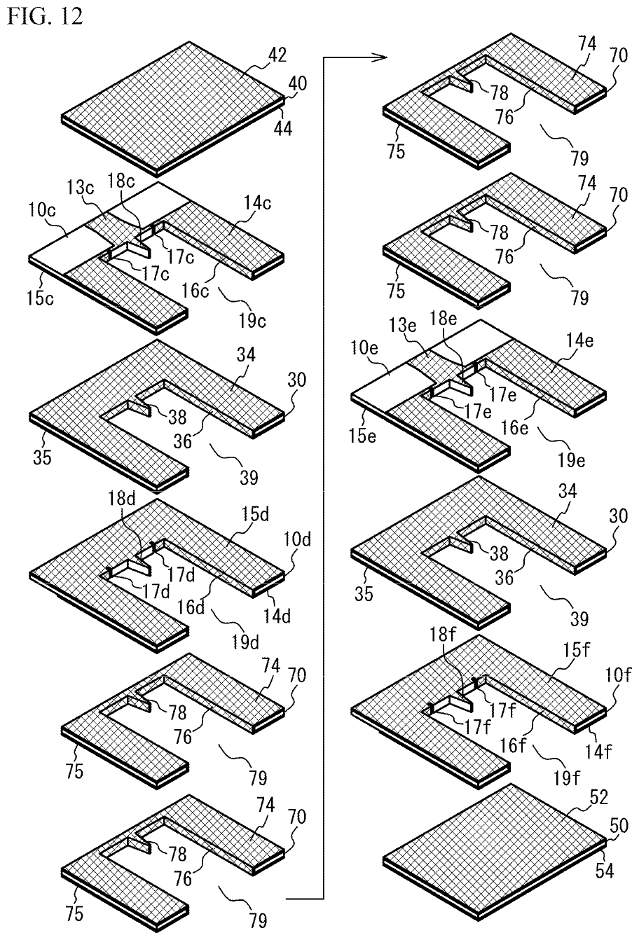

FIG. 10 is a perspective view of a power combiner 200 in accordance with a second embodiment. FIG. 11 is a cross-sectional view taken along line A-A in FIG. 10. FIG. 12 is an exploded perspective view of the power combiner 200 illustrated in FIG. 10. The power combiner 200 of the second embodiment includes four line substrates 10c, 10d, 10e, and 10f as illustrated in FIG. 10 to FIG. 12. The line substrates 10c and 10e have the same structure as the line substrate 10a illustrated in FIG. 4A and FIG. 4B. That is, the line substrate 10c has an opening 19c and a protrusion portion 18c between two notches 17c. A microstrip line 13c and a metal film 14c are provided on the upper face of the line substrate 10c. A metal film 15c is provided on the lower face of the line substrate 10c. A metal film 16c is provided on the side faces of the line substrate 10c in the opening 19c. The line substrate 10e has an opening 19e and a protrusion portion 18e between two notches 17e. A microstrip line 13e and a metal film 14e are provided on the upper face of the line substrate 10e. A metal film 15e is provided on the lower face of the line substrate 10e. A metal film 16e is provided on the side faces of the line substrate 10e in the opening 19e. The metal films 15c and 15e are grounding conductor films provided on the opposite faces of the line substrates 10c and 10e from the microstrip lines 13c and 13e, respectively.

The line substrates 10d and 10f have the same structure as the line substrate 10b illustrated in FIG. 5A and FIG. 5B. That is, the line substrate 10d has an opening 19d and a protrusion portion 18d between two notches 17d. A metal film 15d is provided on the upper face of the line substrate 10d. A microstrip line 13d and a metal film 14d are provided on the lower face of the line substrate 10d. A metal film 16d is provided on the side faces of the line substrate 10d in the opening 19d. The line substrate 10f has an opening 19f and a protrusion portion 18f between two notches 17f. A metal film 15f is provided on the upper face of the line substrate 10f. A microstrip line 13f and a metal film 14f are provided on the lower face of the line substrate 10f. A metal film 16f is provided on the side faces of the line substrate 10f in the opening 19f. The metal films 15d and 15f are grounding conductor films provided on the opposite faces of the line substrates 10d and 10f from the microstrip lines 13d and 13f, respectively.

The intermediate substrates 30 are interposed between the line substrate 10c and the line substrate 10d and between the line substrate 10e and the line substrate 10f. The metal film 34 on the upper face of the intermediate substrate 30 interposed between the line substrate 10c and the line substrate 10d is in contact with the metal film 15c on the line substrate 10c, and the metal film 35 on the lower face is in contact with the metal film 15d on the line substrate 10d. The metal film 34 on the upper face of the intermediate substrate 30 interposed between the line substrate 10e and the line substrate 10f is in contact with the metal film 15e on the line substrate 10e, and the metal film 35 on the lower face is in contact with the metal film 15f on the line substrate 10f.

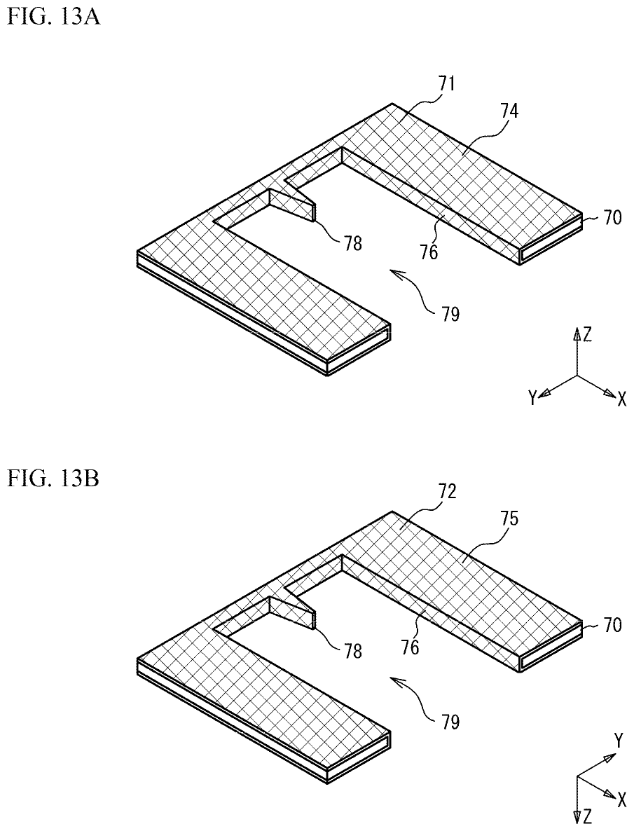

Four intermediate substrates 70 are stacked between the line substrate 10d and the line substrate 10e. FIG. 13A and FIG. 13B are perspective views of the intermediate substrate 70. FIG. 13A is a perspective view of the intermediate substrate 70 viewed from the +Z side, and FIG. 13B is a perspective view of the intermediate substrate 70 viewed from the −Z side. As illustrated in FIG. 13A and FIG. 13B, the center part of the intermediate substrate 70 is cut out to form an opening 79. In addition, the intermediate substrate 70 includes a protrusion portion 78 that protrudes to the opening 79, on the side face of the intermediate substrate 70 in the opening 79. The protrusion portion 78 is provided in a location corresponding to those of the protrusion portions 18c to 18f of the line substrates 10c to 10f and the protrusion portion 38 of the intermediate substrate 30.

As illustrated in FIG. 13A, the upper face 71 of the intermediate substrate 70 is covered with a metal film 74. The metal film 74 is also provided on the protrusion portion 78. As illustrated in FIG. 13B, the lower face 72 of the intermediate substrate 70 is covered with a metal film 75. The metal film 75 is also provided on the protrusion portion 78.

As illustrated in FIG. 13A and FIG. 13B, a metal film 76, which is in contact with the metal film 74 and the metal film 75, is provided on the side faces of the intermediate substrate 70 in the opening 79. The metal film 76 is also provided on the side face, on which the protrusion portion 78 is provided, of the intermediate substrate 70. Thus, the metal film 76 is also provided on the side faces of the protrusion portion 78. As described above, the intermediate substrate 70 has the same structure as the intermediate substrate 30 except the outer shape.

As illustrated in FIG. 10 to FIG. 12, the line substrate 10f, the intermediate substrate 30, the line substrate 10e, the four intermediate substrates 70, the line substrate 10d, the intermediate substrate 30, and the line substrate 10c are stacked in this order in the +Z direction. The upper substrate 40 is provided on the upper face of the line substrate 10c and the lower substrate 50 is provided on the lower face of the line substrate 10f so that the openings 19f, 39, 19e, 79, 19d, 39, and 19c are sandwiched between the upper substrate 40 and the lower substrate 50. This forms a hollow 61a formed of the opening 19c, 39, 19d, 79, 19e, 39, and 19f.

The upper inner wall of the hollow 61a is the lower face of the upper substrate 40, and is covered with the metal film 44. The lower inner wall of the hollow 61a is the upper face of the lower substrate 50, and is covered with the metal film 52. The inner side walls of the hollow 61a are formed of the side faces of the line substrates 10c to 10f in the openings 19c to 19f, the side faces of the intermediate substrate 30 in the opening 39, and the side faces of the intermediate substrates 70 in the opening 79. Since the metal films 16c to 16f, 36, and 76 are provided on the respective side faces, the inner side walls of the hollow 61a are covered with a metal film 62a formed of the metal films 16c to 16f, 36, and 76. Thus, the hollow 61a serves as a hollow waveguide 60a.

The line substrates 10c to 10f are stacked so that the microstrip lines 13c to 13f overlap in the Z-axis direction. In addition, the protrusion portions 18c to 18f, 38, and 78, which are respectively provided to the line substrate 10c to 10f, the intermediate substrate 30, and the intermediate substrate 70, overlap in the Z-axis direction. The overlapping protrusion portions 18c to 18f, 38, and 78 are referred to collectively as a protrusion portion 8a. The protrusion portion 8a has a function that converts the propagation modes of the electromagnetic waves smoothly between the microstrip lines 13c to 13f and the hollow waveguide 60a. Even when neither the protrusion portion 38 nor 78 is provided to the intermediate substrates 30 and 70, low-loss conversion of the electromagnetic waves between the microstrip lines 13c to 13f and the hollow waveguide 60a is possible. However, to further reduce the loss, it is preferable to provide the protrusion portions 38 and 78 also to the intermediate substrates 30 and 70.

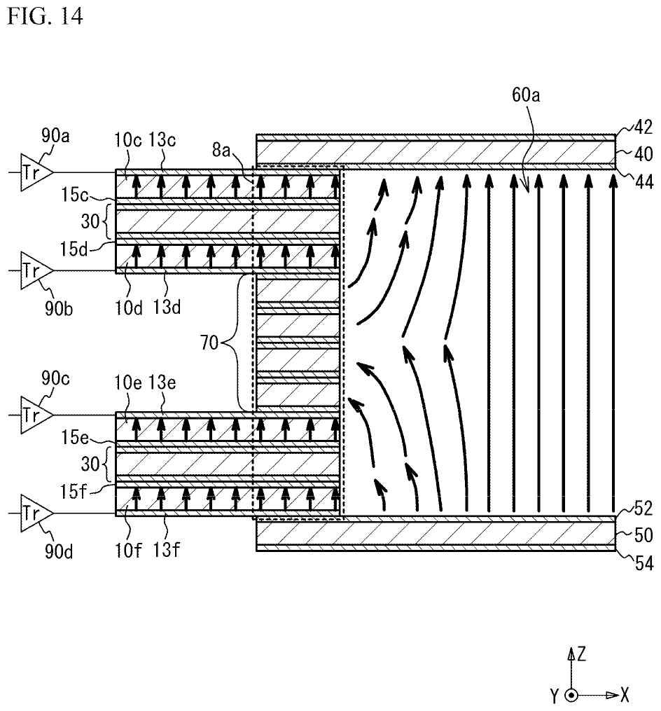

Next, the operation of the power combiner 200 of the second embodiment will be described with reference to FIG. 14. In FIG. 14, arrows express the electric fields generated when the electromagnetic waves propagate through the microstrip lines 13c to 13f High-frequency signals having the same phase are input to the microstrip lines 13c and 13e from two transistors 90a and 90c of four transistors 90a to 90d connected in parallel, for example. High-frequency signals having a reverse phase to the high-frequency signals input to the microstrip lines 13c and 13e are input to the microstrip lines 13d and 13f from the remaining two transistors 90b and 90d. For example, high-frequency signals having an initial phase of 0° are input to the microstrip lines 13c and 13e, and high-frequency signals having an initial phase of 180° are input to the microstrip lines 13d and 13f.

The microstrip lines 13c and 13e are provided on the upper faces of the line substrates 10c and 10e, respectively, while the microstrip lines 13d and 13f are provided on the lower faces of the line substrates 10d and 10f, respectively. In this case, since high-frequency signals having the same phase are input to the microstrip lines 13c and 13e and high-frequency signals having a reverse phase to the high-frequency signals input to the microstrip lines 13c and 13e are input to the microstrip lines 13d and 13f, the electromagnetic waves propagating through the microstrip lines 13c to 13f propagate while the directions of the electric fields are substantially the same.

After the propagation modes of the electromagnetic waves propagating through the microstrip lines 13c to 13f are converted by the protrusion portion 8a, the electric powers of the electromagnetic waves are combined in the hollow waveguide 60a while the directions of the electric fields are substantially the same. This allows the electric powers to be combined while loss is reduced.

### Simulation

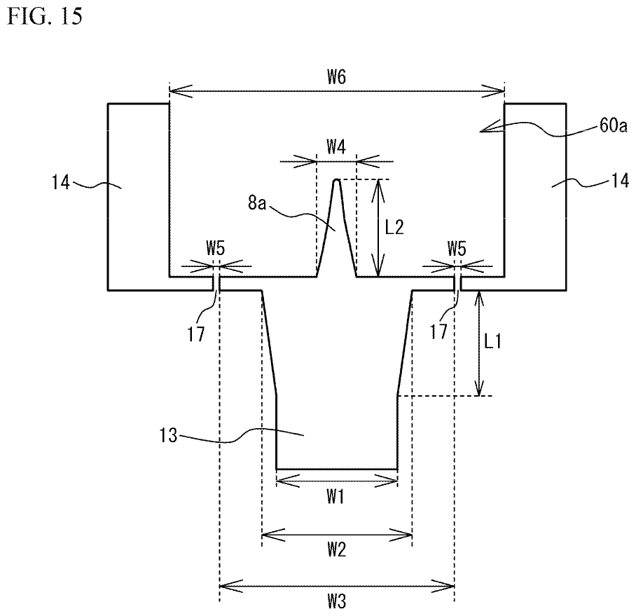

A simulation conducted for the power combiner 200 of the second embodiment will be described. FIG. 15 illustrates dimensions used in the simulation. In FIG. 15, the microstrip lines 13c to 13f are illustrated as a microstrip line 13, the metal films 14c to 14f are illustrated as a metal film 14, and the notches 17c to 17f are illustrated as a notch 17. The protrusion portions 18c to 18f, 38, and 78 are illustrated as the protrusion portion 8a. With reference to FIG. 15, the simulation conditions are presented as follows.

Line substrates 10c to 10f, the intermediate substrates 30 and 70: Rogers RO4003C with a thickness of 1.524 mm

Microstrip lines 13c to 13f: Copper film with a thickness of 35 μm

Metal films 14c to 14f, 15c to 15f, 16c to 16f, 34 to 36, and 74 to 76: Copper film with a thickness of 35 μm

Widths W1 of the microstrip lines 13c to 13f before tapered: 9 mm

Widths W2 of the microstrip lines 13c to 13f after tapered: 11 mm

Taper lengths L1 of the microstrip lines 13c to 13f: 8 mm

Widths W3 between notches of the microstrip lines 13c to 13f: 18 mm

Length L2 of the protrusion portions 18c to 18f, 38, and 78: 7 mm

Maximum widths W4 of the protrusion portions 18c to 18f, 38, and 78: 3 mm

Widths W5 of the notches 17c to 17f: 0.5 mm

Width W6 of the hollow waveguide 60a: 25 mm

Characteristic impedance of the microstrip lines 13c to 13f: 25 Ω

In the simulation, it was assumed that high-frequency signals having the same phase were input to the microstrip lines 13c and 13e and high-frequency signals having a reverse phase to the high-frequency signals input to the microstrip lines 13c and 13e were input to the microstrip lines 13d and 13f.

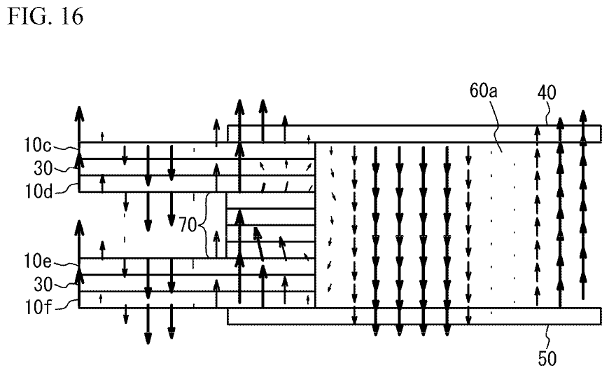

FIG. 16 presents simulation results of the electric field vectors of the power combiner 200 in accordance with the second embodiment. In FIG. 16, the directions of the electric fields generated when the electromagnetic waves propagate through the microstrip lines 13c to 13f are indicated by the directions of the arrows, and the width and the length of the arrow express the magnitude of the electric field. In FIG. 16, the metal films provided on the upper and lower faces of the line substrates 10c to 10f, the intermediate substrates 30 and 70 are not illustrated. As illustrated in FIG. 16, it was confirmed that the electromagnetic waves propagating through the microstrip lines 13c to 13f provided on the line substrates 10c to 10f propagated while the directions of the electric fields were substantially the same. It was also confirmed that the electric powers of the electromagnetic waves were combined in the hollow waveguide 60a while the directions of the electric fields were substantially the same.

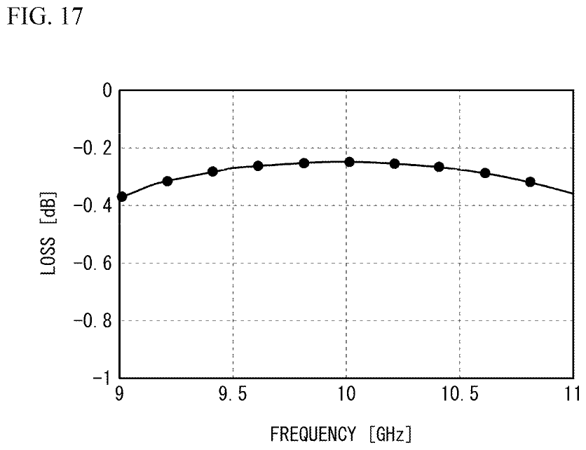

FIG. 17 presents the simulation result of the loss characteristic of the power combiner 200 in accordance with the second embodiment. In FIG. 17, the horizontal axis represents frequency [GHz], and the vertical axis represents loss [dB]. As illustrated in FIG. 17, the transmission loss of the electric power of the power combiner 200 is approximately 0.25 dB at 10 GHz. It was confirmed that the electric powers of the electromagnetic waves propagating through the microstrip lines 13c to 13f were combined with low loss. The reason why the electric powers were combined with low loss is considered because the electric powers of the electromagnetic waves propagating through the microstrip lines 13c to 13f were combined in the hollow waveguide 60a while the directions of the electric fields were substantially the same as illustrated in FIG. 16.

In the second embodiment, the hollow waveguide 60a is coupled to the microstrip lines 13c to 13f The electric powers transmitted through the microstrip lines 13c to 13f are combined by the hollow waveguide 60a to be transmitted. Thus, as in the first embodiment, the size of the power combiner 200 can be reduced.

As in the second embodiment, the electric powers combined by the hollow waveguide are not limited to two electric powers transmitted through two microstrip lines. The electric powers combined by the hollow waveguide may be a plurality of electric powers transmitted through a plurality of microstrip lines such as four electric powers transmitted through four microstrip lines.

### Third Embodiment

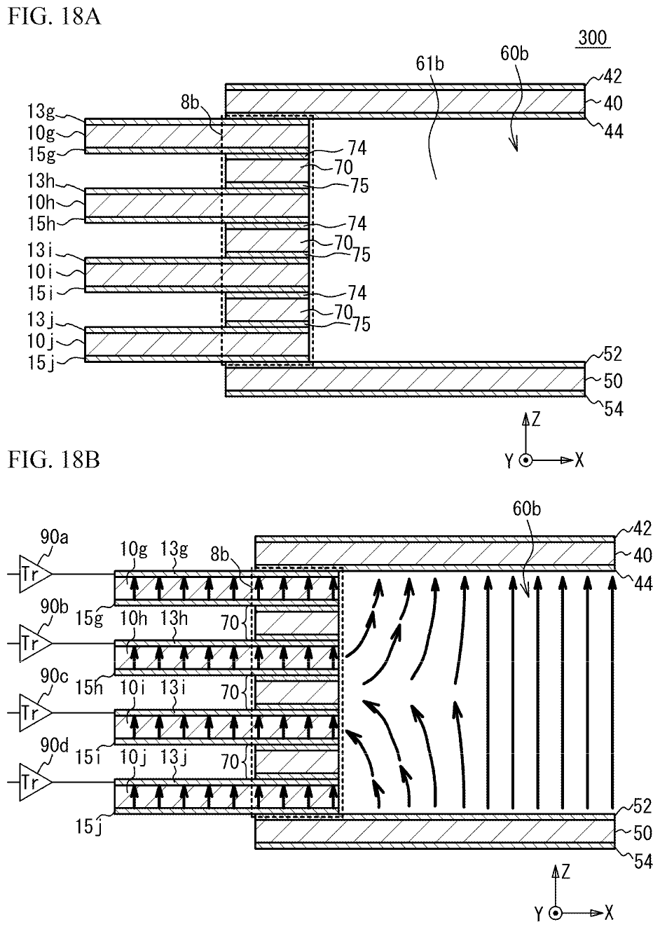

FIG. 18A is a cross-sectional view of a power combiner 300 in accordance with a third embodiment, and FIG. 18B is a cross-sectional view of the operation of the power combiner 300 in accordance with the third embodiment. In the power combiner 300 of the third embodiment, the lower substrate 50, a line substrate 10j, the intermediate substrate 70, a line substrate 10i, the intermediate substrate 70, a line substrate 10h, the intermediate substrate 70, a line substrate 10g, and the upper substrate 40 are stacked in this order in the +Z direction as illustrated in FIG. 18A. The line substrates 10g to 10j have the same structure as the line substrate 10a illustrated in FIG. 4A and FIG. 4B. Therefore, the line substrates 10g to 10j have microstrip lines 13g to 13j formed on the upper faces thereof, respectively. A hollow 61b formed of respective openings of the line substrates 10g to 10j and the openings of the intermediate substrates 70 serves as a hollow waveguide 60b. The electric powers transmitted through the microstrip lines 13g to 13j are transmitted to the hollow waveguide 60b through a protrusion portion 8b provided to the line substrates 10g to 10j and the intermediate substrates 70. Other structures are the same as those of the second embodiment, and the description thereof is thus omitted.

As illustrated in FIG. 18B, high-frequency signals having the same phase are input to the microstrip lines 13g to 13j from four transistors 90a to 90d connected in parallel, for example. For example, high-frequency signals having an initial phase of 0° are input to the microstrip lines 13g to 13j. Since the microstrip lines 13g to 13j are provided on the upper faces of the line substrates 10g to 10j, respectively, when high-frequency signals having the same phase are input to the microstrip lines 13g to 13j, the electromagnetic waves propagating through the microstrip lines 13g to 13j propagate while the directions of the electric fields are substantially the same. Therefore, the electric powers of the electromagnetic waves are combined in the hollow waveguide 60b while the directions of the electric fields are substantially the same. Therefore, the electric powers are combined while loss is reduced.

In the third embodiment, the hollow waveguide 60b is coupled to the microstrip lines 13g to 13j. The electric powers transmitted through the microstrip lines 13g to 13j are combined by the hollow waveguide 60b to be transmitted. Therefore, as in the first embodiment, the size of the power combiner 300 can be reduced.

In addition, in the third embodiment, the microstrip line 13g is provided on the upper face, which is the opposite face of the line substrate 10g from the line substrate 10h, of the line substrate 10g, and the microstrip line 13h is provided on the upper face, which is closer to the line substrate 10g, of the line substrate 10h. Similarly, the microstrip line 13h is provided on the upper face, which is the opposite face of the line substrate 10h from the line substrate 10i, of the line substrate 10h, and the microstrip line 13i is provided on the upper face, which is closer to the line substrate 10h, of the line substrate 10i. The microstrip line 13i is provided on the upper face, which is the opposite face of the line substrate 10i from the line substrate 10j, of the line substrate 10i, and the microstrip line 13j is provided on the upper face, which is closer to the line substrate 10i, of the line substrate 10j. This structure causes the electric powers of the electromagnetic waves to be combined in the hollow waveguide 60b while the directions of the electric fields are substantially the same when high-frequency signals having the same phase are input to the microstrip lines 13g to 13j. Therefore, the power combiner 300 supporting the case where high-frequency signals having the same phase are input is achieved.

### Fourth Embodiment

In the first to third embodiments, the input side of the hollow waveguide to which high-frequency signals are input is described. In fourth and fifth embodiments, the output side of the hollow waveguide from which a high-frequency signal is output will be described. In the fourth and fifth embodiments, a case where the input side has the structure of the power combiner 200 of the second embodiment will be described as an example.

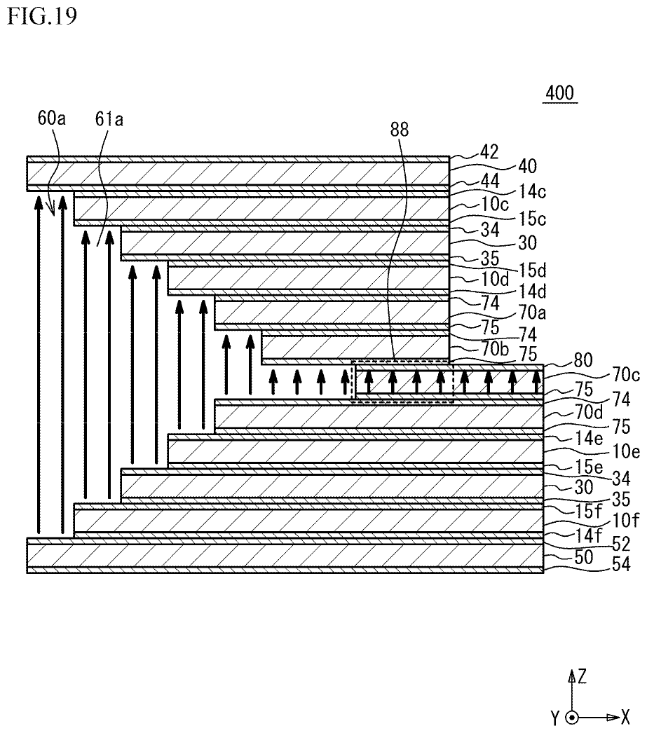

FIG. 19 is a cross-sectional view of a power combiner 400 in accordance with the fourth embodiment. In FIG. 19, the electric field of the electromagnetic wave propagating through the hollow waveguide 60a is expressed by arrows. In the power combiner 400 of the fourth embodiment, a microstrip line 80 and a protrusion portion 88 are provided to an intermediate substrate 70c, which is in the middle, of four intermediate substrates 70a to 70d stacked between the line substrates 10d and 10e as illustrated in FIG. 19. The microstrip line 80 transmits the electric power transmitted through the hollow waveguide 60a after the mode conversion by the protrusion portion 88.

The +X side ends of the openings of the intermediate substrate 70b, the intermediate substrate 70a, the line substrate 10d, the intermediate substrate 30, and the line substrate 10c, which are located at the +Z side more than the intermediate substrate 70c and are arranged in this order in the +Z direction, are shifted to the −X side in this order. The +X side ends of the openings of the intermediate substrate 70d, the line substrate 10e, the intermediate substrate 30, and the line substrate 10f, which are located at the −Z side more than the intermediate substrate 70c and are arranged in this order in the −Z direction, are shifted to the −X side in this order. The +X side end of the opening of the intermediate substrate 70c is located at the most +X side among those of the substrates. Thus, the height (the length in the Z-axis direction) of the hollow waveguide 60a decreases in a stepwise shape toward the intermediate substrate 70c provided with the microstrip line 80. Other structures are the same as those of the power combiner in accordance with the second embodiment, and the description thereof is thus omitted.

In the fourth embodiment, the height of the hollow waveguide 60a gradually decreases toward the intermediate substrate 70c provided with the microstrip line 80 to which the electric power transmitted through the hollow waveguide 60a is input. This allows the high-frequency signal transmitted through the hollow waveguide 60a to be transmitted to the microstrip line 80 with low loss.

In addition, in the fourth embodiment, the height of the hollow waveguide 60a decreases in a stepwise shape toward the intermediate substrate 70c. Since the height of the hollow waveguide 60a decreases in a stepwise shape, the structure where the height of the hollow waveguide 60a gradually decreases can be easily achieved. For example, the stepwise level difference of the hollow waveguide 60a can be formed by the line substrates 10c to 10f, and the intermediate substrates 30 and 70a to 70d.

### Fifth Embodiment

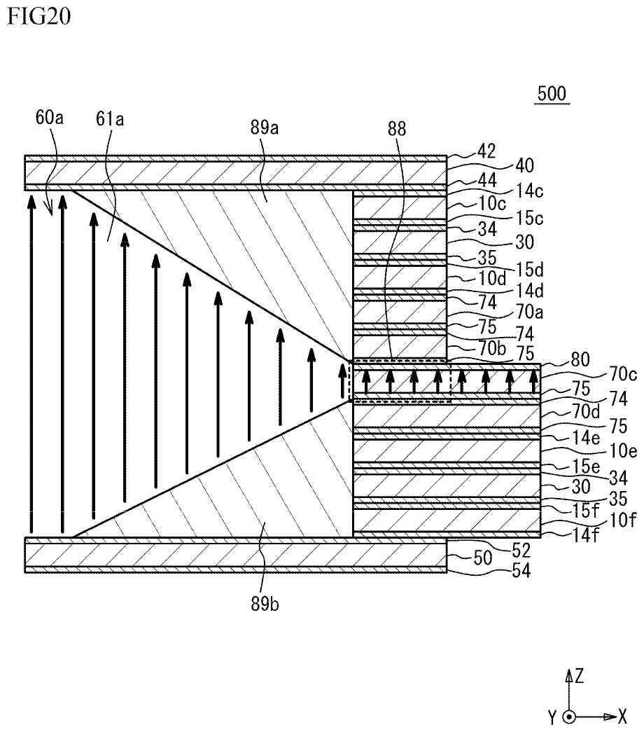

FIG. 20 is a cross-sectional view of a power combiner 500 in accordance with the fifth embodiment. In FIG. 20, the electric field of the electromagnetic wave propagating through the hollow waveguide 60a is expressed by arrows. As illustrated in FIG. 20, in the power combiner 500 of the fifth embodiment, as in the power combiner 400 of the fourth embodiment, the microstrip line 80 and the protrusion portion 88 are provided to the intermediate substrate 70c, which is in the middle, of the four intermediate substrates 70a to 70d stacked between the line substrates 10d and 10e.

The +X side ends of the openings of the line substrates 10c to 10f and the intermediate substrates 30 and 70a to 70d are substantially aligned. In the hollow 61a formed of these openings, a metal member 89a having a slope face sloping from the upper substrate 40 toward the intermediate substrate 70c and a metal member 89b having a slope face sloping from the lower substrate 50 to the intermediate substrate 70c are disposed. The metal members 89a and 89b are, for example, blocks made of copper. Since the metal members 89a and 89b are provided, the height (the length in the Z-axis direction) of the hollow waveguide 60a decreases in a tapered shape toward the intermediate substrate 70c provided with the microstrip line 80. Other structures are the same as those of the power combiner in accordance with the second embodiment, and the description thereof is thus omitted.

In the fifth embodiment, as in the fourth embodiment, the height of the hollow waveguide 60a gradually decreases toward the intermediate substrate 70c provided with the microstrip line 80 to which the electric power transmitted through the hollow waveguide 60a is input. Therefore, the high-frequency signal transmitted through the hollow waveguide 60a can be transmitted to the microstrip line 80 with low loss.

In addition, in the fifth embodiment, the height of the hollow waveguide 60a decreases in a tapered shape toward the intermediate substrate 70c. Since the height of the hollow waveguide 60a decreases in a tapered shape toward the intermediate substrate 70c, the high-frequency signal transmitted through the hollow waveguide 60a can be transmitted to the microstrip line 80 with further low loss.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A power combiner comprising:
a first substrate provided with a first microstrip line;
a second substrate provided with a second microstrip line; and
a hollow waveguide having a metal film on an inner wall of a hollow and coupled to the first microstrip line and the second microstrip line, the hollow waveguide combining a first electric power transmitted through the first microstrip line and a second electric power transmitted through the second microstrip line and transmitting a combined electric power.

2. The power combiner according to claim 1, wherein the hollow waveguide is formed of openings of substrates including the first substrate and the second substrate that are stacked.

3. The power combiner according to claim 1, wherein the first substrate and the second substrate are stacked so that the first microstrip line and the second microstrip line overlap in a stack direction.

4. The power combiner according to claim 1,
wherein the first substrate and the second substrate are stacked,
wherein the first microstrip line is provided on an opposite face of the first substrate from the second substrate,
wherein the second microstrip line is provided on an opposite face of the second substrate from the first substrate.

5. The power combiner according to claim 4, further comprising:
a third substrate that is interposed between the first substrate and the second substrate, has a first metal film on a face closer to the first substrate, and has a second metal film on a face closer to the second substrate, the first metal film overlapping the first microstrip line, the second metal film overlapping the second microstrip line.

6. The power combiner according to claim 1,
wherein the first substrate and the second substrate are stacked,
wherein the first microstrip line is provided on an opposite face of the first substrate from the second substrate,
wherein the second microstrip line is provided on a face closer to the first substrate of the second substrate.

7. The power combiner according to claim 6, wherein an air gap to which the second microstrip line is exposed is provided between the first substrate and the second substrate.

8. The power combiner according to claim 1,
wherein the first substrate includes a first protrusion portion protruding to the hollow waveguide and provided with the first microstrip line,
wherein the second substrate includes a second protrusion portion protruding to the hollow waveguide and provided with the second microstrip line,
wherein the first substrate and the second substrate are stacked so that the first protrusion portion and the second protrusion portion overlap in a stack direction,
wherein the first electric power is transmitted to the hollow waveguide through the first protrusion portion,
wherein the second electric power is transmitted to the hollow waveguide through the second protrusion portion.

9. The power combiner according to claim 1, further comprising:
a third substrate provided with a third microstrip line to which an electric power transmitted through the hollow waveguide is input,
wherein a height of the hollow waveguide gradually decreases toward the third substrate.

10. The power combiner according to claim 9, wherein the height of the hollow waveguide decreases in a stepwise shape toward the third substrate.

11. The power combiner according to claim 10, wherein a stepwise level difference is formed by substrates including the first substrate and the second substrate that are stacked.

12. The power combiner according to claim 9, wherein a height of the hollow waveguide decreases in a tapered shape toward the third substrate.

13. The power combiner according to claim 12, wherein a tapered slope is formed by a metal member provided in the hollow waveguide.
